(19) United States
(12) Patent Application Publication
(10) Pub. No.: US 2025/0283561 A1
(43) Pub. Date: Sep. 11, 2025

(54) PIPE FITTINGS INCLUDING A DUAL DRIVE FASTENER AND RELATED FASTENERS AND METHODS

(71) Applicant: Sensus Spectrum, LLC, Morrisville, NC (US)

(72) Inventors: Isaac Davis, Ashdown, AR (US); Cory Dodson, Texarkana, TX (US)

(21) Appl. No.: 19/070,770

(22) Filed: Mar. 5, 2025

Related U.S. Application Data
(60) Provisional application No. 63/561,439, filed on Mar. 5, 2024.

(51) Int. Cl. F16L 21/06; F16L 21/02

(52) U.S. Cl. CPC F16L 21/065; F16L 21/02

(57) ABSTRACT

A pipe fitting is provided including a sleeve having a generally cylindrical body portion with at least one open end configured to receive at least one pipe; a sealing gasket operatively coupled with the sleeve for engaging at least one pipe end of the at least one pipe; a clamping element operatively coupled with the sleeve for compressing the sealing gasket into tightened engagement with the at least one of the pipe end, the clamping element including one or more flanges; and one or more fastening elements that engages the one or more flanges to tighten the pipe fitting from an uncompressed position to a sealed engagement position with use of industry standard equipment.

### CROSS-REFERENCE TO PRIORITY APPLICATION

This application claims priority to and the benefit of U.S. Provisional Application No. 63/561,439, filed Mar. 5, 2024, the content of which is hereby incorporated herein in its entirety.

### FIELD

The present inventive concept relates generally to pipe fittings and, more particularly, to fasteners that improve efficiency in the installation process of pipe fittings.

### BACKGROUND

Various types of conventional pipe couplings for coupling and sealing adjacent pipe ends of two pipe sections include a coupling sleeve or collar with each pipe end extending into a respective end of the coupling sleeve. A gasket is held adjacent to each end of the sleeve overlying the pipe section, or alternatively, along the length of the sleeve. To join pipe ends the gasket(s) generally must be compressed against the sleeve and onto the pipe ends to form a tightened or sealing engagement. The various types of pipe couplings available today include different types of clamping elements or mechanisms for producing this selective compression on the sleeve and/or the gasket(s).

Many of the conventional pipe couplings used in the field today are installed and adjusted using threaded bolts and nuts. Typically, a socket wrench or similar tool must be used to rotate the nuts/fasteners to perform the installation process. However, many pipe couplings are provided with a wide range of adjustable compression that may be applied, thus, the bolts may need to be moved a significant length or distance during the tightening of the pipe coupling onto the pipe ends. In addition to requiring more time and manual labor for longer movements, specialty sockets must sometimes be provided to handle the long length of movement from the starting or nominal (uncompressed) position to the fully compressed and sealed engagement position. The added complexity of parts and tools for the job may be undesirable when working in the field, such as when an installer is working in dark or poor environmental conditions on a buried pipe connection.

As such, it would be desirable to further improve the various types of conventional pipe couplings to reduce a number of separate or loose parts and tools that an installer must work with when connecting two pipe ends using the pipe coupling. Furthermore, it would also be desirable to reduce the time and manual labor required to install these pipe couplings, thereby making the users more efficient overall.

### SUMMARY

Some of the embodiments of the present inventive concept provide a pipe fitting including a sleeve having a generally cylindrical body portion with at least one open end configured to receive at least one pipe; a sealing gasket operatively coupled with the sleeve for engaging at least one pipe end of the at least one pipe; a clamping element operatively coupled with the sleeve for compressing the sealing gasket into tightened engagement with the at least one of the pipe end, the clamping element including one or more flanges; and one or more fastening elements that engages the one or more flanges to tighten the pipe fitting from an uncompressed position to a sealed engagement position with use of industry standard equipment.

In further embodiments, the one or more flanges may be coupled by one or more fastening elements and the one or more fastening elements may extend generally tangential to the generally cylindrical body portion of the sleeve and through the one or more flanges that, when tightened, creates radially applied clamping force to tightened engagement with the use of industry standard equipment.

In still further embodiments, the one or more fastening elements may be one or more fastening bolts. Each of the one or more fastening bolts may have a distinctive hexagonal head with an adjusted head height that enables engagement of industry standard equipment.

In some embodiments, the distinctive hexagonal head may further include a recessed portion that receives industry standard equipment to tighten the bolt.

In further embodiments, the one or more flanges may include first and second flanges, the clamping element may further include a set of two or more small fasteners and the one or more fastening bolts may couple the first and second flanges at a first end and the set of two or more small fasteners may couple the first and second flanges at a second end, opposite the first end.

In still further embodiments, the one or more fastening elements may be actuated from a head of the fastening bolt. Actuating the bolt head may result in a reduction in heat generation at a nut/bolt interface. The fastening bolt may be actuated by a standard depth socket and/or square drive equipment.

In some embodiments, tightening the fastening bolt may provide a force required to create a seal between the sealing gasket and the at least one pipe end and engage a grip ring by bending the first and second flanges inward.

In further embodiments, when fully tightened, a gap may be present between ends of the first and second flanges.

In still further embodiments, the fastening bolt may be paired with a washer and nut that are mated by shape to flange pockets allowing the first and second flanges to articulate as the fastening bolt is tightened. The washer may be a swivel washer, and the nut may be a swivel nut.

In some embodiments, standard industry equipment may include industry-standard ratchets, torque wrenches and/or electric/pneumatic impact drivers.

Further embodiments of the present inventive concept provide fasteners for use with a pipe fitting, the fastener comprising one or more fastening bolts having a distinctive hexagonal head with an adjusted head height, the one or more fastening bolts coupling one or more flanges of the pipe fitting and extending generally tangential to a generally cylindrical body portion of a sleeve of the pipe fitting and through the one or more flanges that, when tightened, create a radially applied clamping force to tightened engagement with the use of industry standard equipment.

Still further embodiments of the present inventive concept provide methods for fastening a pipe fitting having a sleeve, a sealing gasket operatively coupled with the sleeve for engaging at least one pipe end of at least one pipe, a clamping element operatively coupled with the sleeve for compressing the sealing gasket into tightened engagement with the at least one of the pipe end, the clamping element including one or more flanges; one or more fastening elements, the method including activating the one or more fastening elements that engages the one or more flanges to tighten the pipe fitting from an uncompressed position to a sealed engagement position using industry standard equipment.

### BRIEF DESCRIPTION OF THE DRAWINGS

FIG. 1 is a diagram illustrating an exploded view of a pipe coupling in accordance with some embodiments of the present inventive concept.

FIG. 2 is a perspective view of a fully assembled pipe coupling in accordance with some embodiments of the present inventive concept.

FIG. 3 is a diagram illustrating a distinctive bolt head including a standard depth socket in accordance with some embodiments of the present inventive concept.

FIG. 4 is a diagram illustrating a bolt being used with tools in accordance with some embodiments of the present inventive concept.

FIG. 5 is a front view of the pipe coupling including the fastener having a first width (uncompressed) between the flanges in accordance with some embodiment of the present inventive concept.

FIG. 6 is a front view of the pipe coupling including the fastener having a second, different width (compressed) between the flanges in accordance with some embodiment of the present inventive concept.

FIG. 7 is a diagram illustrating a distinctive bolt head that does not include a recessed square direct drive in accordance with some embodiments of the present inventive concept.

FIG. 8 is a diagram illustrating a perspective view of the pipe coupling including the distinctive bolt head illustrated in FIG. 7 in accordance with some embodiments of the present inventive concept.

### DETAILED DESCRIPTION

The present inventive concept will be described more fully hereinafter with reference to the accompanying figures, in which embodiments of the inventive concept are shown. This inventive concept may, however, be embodied in many alternate forms and should not be construed as limited to the embodiments set forth herein.

Accordingly, while the inventive concept is susceptible to various modifications and alternative forms, specific embodiments thereof are shown by way of example in the drawings and will herein be described in detail. It should be understood, however, that there is no intent to limit the inventive concept to the particular forms disclosed, but on the contrary, the inventive concept is to cover all modifications, equivalents, and alternatives falling within the spirit and scope of the inventive concept as defined by the claims. Like numbers refer to like elements throughout the description of the figures.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this inventive concept belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

As discussed above, conventional pipe couplings generally require more time and manual labor to install. Furthermore, multiple tools, for example, specialty sockets, may be needed to handle an extended length of movement from the starting or nominal (uncompressed) position to the fully compressed and sealed engagement position. The added complexity of parts and tools for the job may be undesirable when working in the field, such as when an installer is working in dark or poor environmental conditions on a buried pipe connection. Improved pipe couplings that may reduce a number of separate or loose parts and tools that an installer uses when connecting two pipe ends using the pipe coupling are desired. Furthermore, it would also be desirable to reduce the time and manual labor required to install these pipe couplings, thereby making the users more efficient overall.

Accordingly, some embodiments of the present inventive concept provide a fitting/fastener that can be tightened without the need for a socket or similar tool. In other words, the fastener can be tightened using industry standard equipment, such as industry-standard ratchets, torque wrenches and/or electric/pneumatic impact drivers. Eliminating the need for sockets makes hardware installation more efficient. For example, as discussed above, installers have a dependency on sockets to install hardware on site. Some fittings call for specialty sockets, such as extra deep impact-rated sockets that are not readily available in retail stores. As will be discussed in detail below, the distinctive bolt head design of the fastener in accordance with some embodiments of the present inventive concept operates without using sockets, making hardware installation faster and hassle-free. Details with respect to embodiments of the present inventive concept will now be discussed with respect to the figures.

As used herein, “fitting” refers to any type of equipment that connects two elements or parts, for example, fittings, couplings, fastener, split rings and the like. Furthermore, although the examples discussed herein refer to “pipe couplings,” embodiments of the present inventive concept are not limited thereto. The fittings/couplings discussed herein can be used in combination with any equipment in need of such fittings.

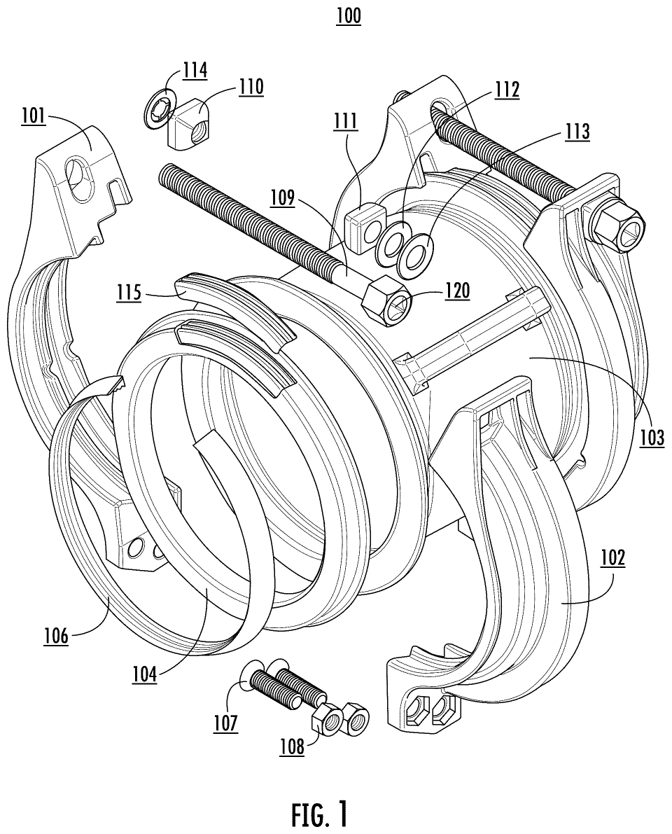

Referring first to FIG. 1, an exploded view of the pipe coupling 100 including the fastener/fitting 109 in accordance with some embodiments of the present inventive concept will be discussed. It will be understood that embodiments of the present inventive concept are directed to the fastener itself and the details associated therewith, such as actuation. Details with respect to the pipe coupling are discussed in, for example, commonly assigned U.S. Pat. Nos. 9,791,077 and 10,648,599 and U.S. patent application Ser. No. 18/629,020, the disclosures of which are hereby incorporated herein by reference as set forth in their entirety.

As illustrated in FIG. 1, the pipe coupling includes left 101 and right 102 flanges, a sleeve 103, a gasket with molded in armor 104, armor 115, a grip ring 106, screws 107 and corresponding nuts 108, the fastener 109 (bolt) or fastening element, a nut 110, and washer 111, and additional washers 112, 113 and 114. It will be understood that the exploded view of the pipe coupling 100 in FIG. 1 is provided as an example only, embodiments of the present inventive concept are not limited thereto. For example, in some embodiments, the flanges may be a single piece and not left and right flanges. The pipe coupling 100 provides context for the fastener 109 in accordance with embodiments discussed herein. However, the fastener 109 may be used with other elements that need to be connected without departing from the scope of the present inventive concept.

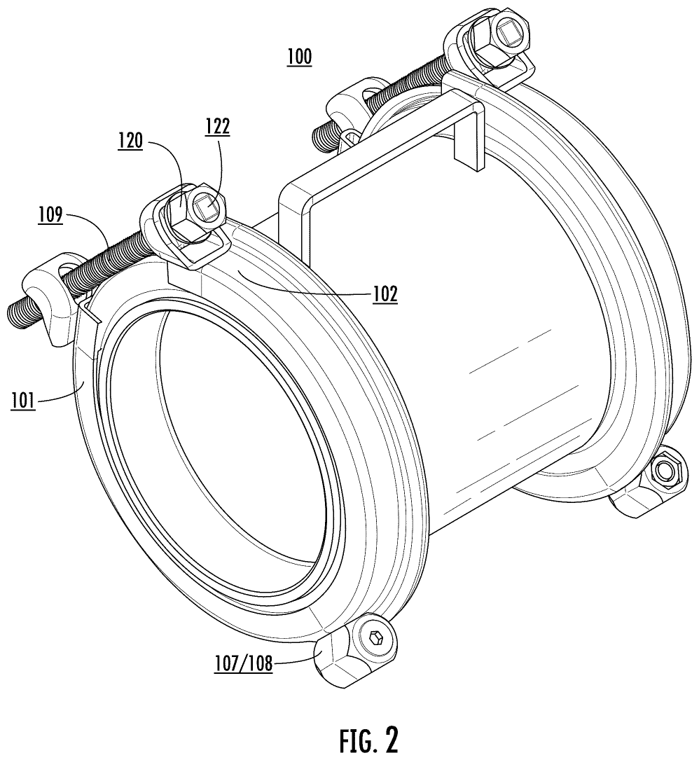

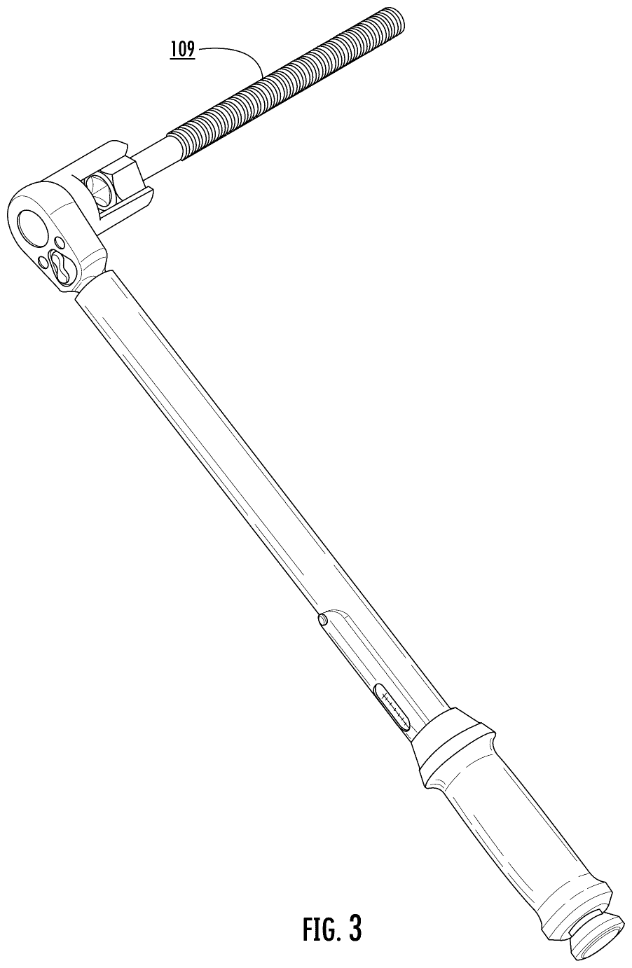

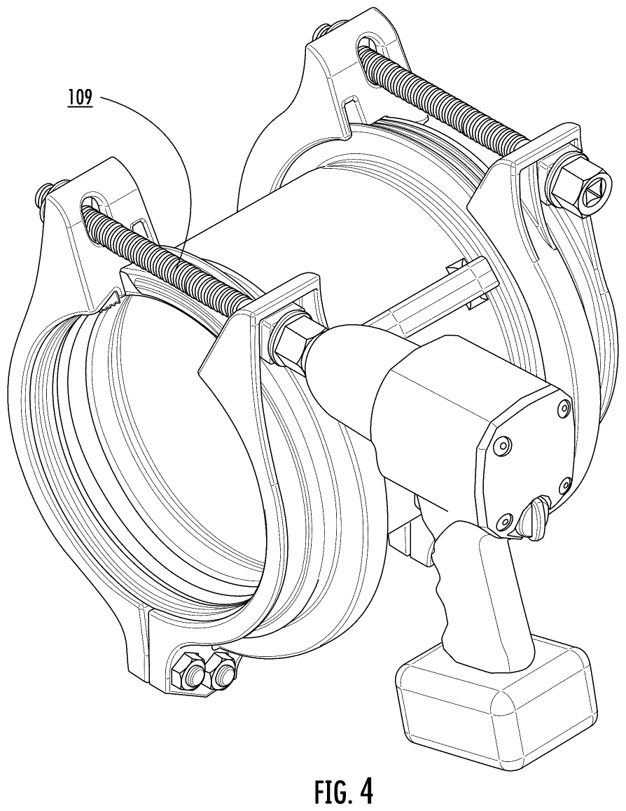

As illustrated in FIG. 1, in some embodiments the fastener 109 may be a bolt 109 having a distinctive bolt head 120 that allows for tightening with, for example, square drive equipment tools or sockets. The distinctive bolt head in FIG. 1 has a hexagon shape 120 and a drive feature (122, FIG. 2). Furthermore, the distinctive bolt head 120 having the hexagon shape has an increased head height relative to conventional bolt heads, which allows the distinctive hexagon head 120 to bear the surface of the socket. Thus, bolts 109 in accordance with embodiments discussed herein can be tightened with both square drive equipment tools or standard sockets. Sockets are not necessary. Use of the bolt 109 in accordance with embodiments discussed herein with a standard socket is illustrated, for example, in FIG. 3 and square drive equipment tools in FIG. 4. FIGS. 3 and 4 are provided for example only.

As discussed above, by eliminating the need for the socket, the fastener/bolt 109 makes hardware installation more efficient. In particular, primary actuation of the bolt 109 with a square drive (discussed below) eliminates the need for sockets to install, for example, pipe fittings, removing dependency on sockets. Secondary actuation with the distinctive hexagonal head 120 eliminates the need for extra deep sockets as the actuation can be performed using standard sockets. Furthermore, actuating the bolt head 120 instead of the nut, in some embodiments, will result in a reduction in heat generation at the nut/bolt interface. In other words, actuating the bolt head against a bearing surface that has no threads that has no threads removes one source of heat generation present in prior embodiments. Reducing the heat, at the nut/bolt interface, may result in decreased galling in hardware, improved torque transfer and increased product performance.

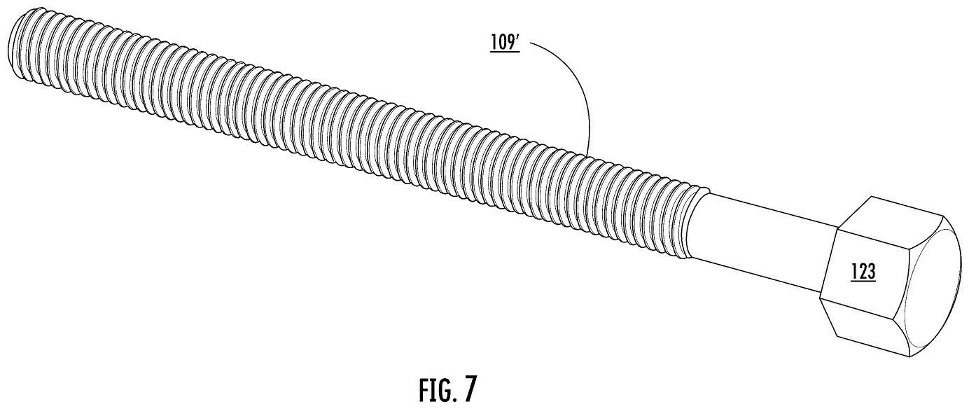

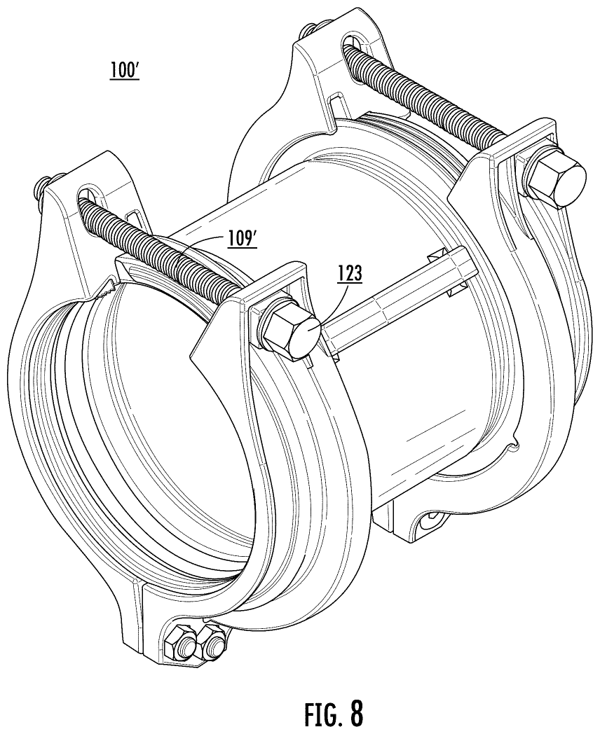

It will be understood that some embodiments of the present inventive concept include a bolt 109 with a distinctive hexagonal head 120 including a square drive 122, for example, as illustrated in FIG. 2. In particular, the bolt head 120 may further include a recessed square drive 122 that enables use of other tools to tighten the bolt. As illustrated, the bolt 109 extends through a washer that does not have threads and tightens into the nut that has threads. It will be understood that in some embodiments the washer and corresponding nut may be a swivel washer and a swivel nut, respectively, however, embodiments of the present inventive concept are not limited thereto. In these embodiments, the head of the bolt is tightened, not the nut. Thus, a single bolt compression is achieved with a standard socket, i.e., no extra long or specialty sockets are needed. Although FIG. 2 illustrates the distinctive hexagonal head 120 including the recessed square drive 122, embodiments of the present inventive concept are not limited thereto. As illustrated in FIGS. 7 and 8, the bolt 109′ may be provided with a distinctive hexagonal head 123 that does not include the recessed square drive 122 shown in FIG. 2. It will be understood that the embodiments of the present inventive concept that do not include the recessed square drive 122 as shown in FIG. 7 still have the advantage of using standard sockets.

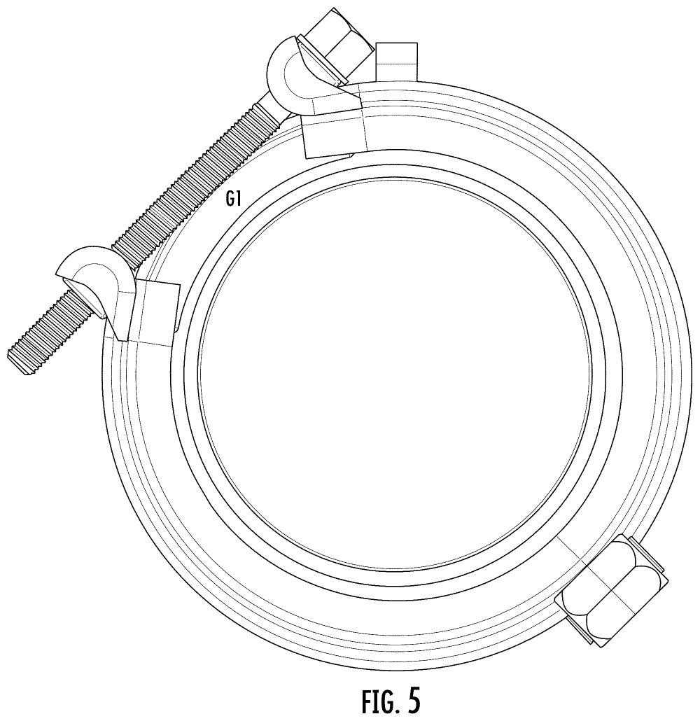

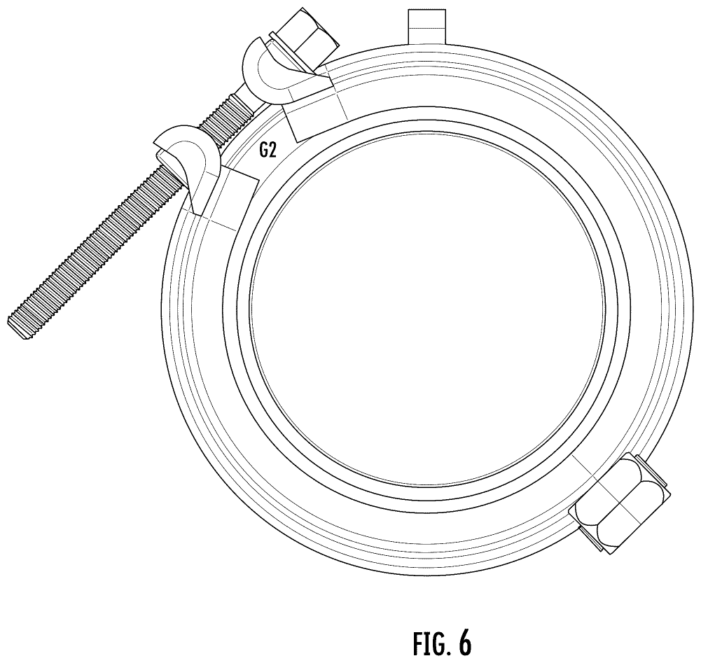

Referring now to FIG. 2, details of the distinctive hexagonal bolt head 120 will be discussed. FIG. 2 is a perspective view of a fully assembled pipe coupling 100 in accordance with embodiments of the present inventive concept. As illustrated the flanges 101 and 102 are connected at a bottom portion by the screws 107 and corresponding nuts 108 and compressed together at a top portion by the fastener 109 leaving a gap G therebetween. It will be understood that the width of the gap G between the top two portions of the fastener 101/102 is not standard and may be different based on the pipe being coupled. FIGS. 5 and 6 show two different widths G1 and G2, respectively, of the gap, however, embodiments of the present inventive concept are not limited thereto. In particular, the first width G1 is uncompressed. This width is representative of when the pipe coupling is initially assembled and in a relaxed state. The second width G2 is representative of the pipe coupling in a compressed state, thus G2 is smaller than G1. Any width may be accommodated without departing from the scope of the present inventive concept.

When fully assembled, the washer 111 (FIG. 1) is positioned under the head 120 of the bolt 109 engaged with flange 102. Furthermore, the nut 110 threads on to the bolt 109, interfacing with opposite flange 101, therefore, not visible in FIG. 2. Unlike conventional fasteners, radial compression of fasteners, like that used in the Top-Bolt coupling, requires swivel hardware. This swivel hardware allows the bolt to maintain its tangency to the coupling. Furthermore, in some embodiments, washers 112 and 113 may be placed between the washer 111 and the head 120 of the bolt 109 to promote torque. However, some embodiments may be free of the washers without departing from the scope of the present inventive concept.

As illustrated in embodiments of FIG. 2, the bolt head 120 has a distinctive hexagonal-shaped head and a recessed square drive 122. The recessed square drive 122 in the bolt head 120 is visible in FIG. 2. In some embodiments, the bolt 109 may be referred to as a dual drive bolt. In particular, within the bolt head 120, the recessed square drive 122 is an industry-standard female mating drive that can interact with almost all installation tools. For example, the recessed square drive is compatible with industry-standard ratchets, torque wrenches, electric/pneumatic impact drivers and the like, all of which have a male square drive compatible with the recessed square drive 122 of the bolt head. Thus, the industry standard male square drive mates with the bolt head 120 similar to how it mates with sockets, thus eliminating the need for the socket. In other words, having the recessed drive feature 122 in the bolt head 120 eliminates the need for a socket to mate up with the tool.

Furthermore, the distinctive hexagonal-shaped head allows the bolt 109 to retain the ability to also be actuated by means of a standard socket. Typical bolting systems are actuated by socket-to-nut interaction. However, the dual drive bolt 109 is actuated by the bolt head instead of the nut. By actuating the bolt head instead of the nut, the shank of the bolt 109 does not extend into the tool being used, thus not requiring a deep or extra-deep socket to accommodate the shank of the bolt. Traditional bolting systems require a deep or extra-deep socket to accommodate the bolt shank extension. The dual drive bolt design 109 retains industry-standard length sockets or common ratchet wrenches as an alternative to the primary actuating means. Thus, although the bolt 109 in accordance with embodiments of the present inventive concept does not need a socket for actuation, a socket may still be used, making the fastener discussed herein extremely versatile.

As discussed above, the dual drive bolt 109 experiences a reduction in heat generation at the nut-bolt interface. Since the tool is actuating the bolt head, less frictional heat is generated at the nut-bolt interface due to the actuating bearing surface no longer being adjacent to the threaded interface. This will decrease the effects of galling in hardware, improve torque transfer, and increase product performance.

The most common square drive sizes across the industry at the present time are ¼-inch, ⅜-inch and ½-inch. Equipment that installers use is typically equipped with a ½-inch drive size. In some embodiments, the dual drive bolt system discussed herein may be standardized around the ½-inch drive system but is not limited to this size. Other drive sizes may be used without departing from the scope of the present inventive concept. If users have a drive tool not sized for the bolt, an adaptor may be required to use the square drive.

Similarly, there are multiple hexagonal head sizes. The two most common bolt sizes in the industry are ⅝-inch (1 1/16-inch hexagonal head) and ¾-inch (1¼ inch hexagonal head). The dual drive bolt system can be configured in any hexagonal head size without departing from the scope of the present inventive concept.

As discussed briefly above, pipe fitting installers rely on various socket sizes to install hardware. Installers often need to purchase deep and extra-deep sockets in addition to standard length sockets, resulting in higher tooling costs and more inventory to manage. There are at least six socket sizes installers are required to always have on hand to install common pipe fittings. Accordingly, the bolt system in accordance with embodiments of the present inventive concept eliminates the need to have sockets. The bolt of the present inventive concept allows installers to use common installation tools such as ratchets, torque wrenches, and electric/pneumatic impact drivers straight out of the box without using sockets. The bolt head features a distinctive hexagonal design that allows industry-standard length sockets or common ratchet wrenches to be utilized as an alternative to the primary actuating means. By actuating the bolt head instead of the nut, the need for deep or extra-deep sockets is eliminated.

It will be understood that although the figures of the present application depict a bolt that is tightened by turning the bolt to the right, embodiments of the present inventive concept are not limited thereto. Both right and left configurations are intended to be covered by the present disclosure.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A pipe fitting, comprising:
a sleeve having a generally cylindrical body portion with at least one open end configured to receive at least one pipe;
a sealing gasket operatively coupled with the sleeve for engaging at least one pipe end of the at least one pipe;
a clamping element operatively coupled with the sleeve for compressing the sealing gasket into tightened engagement with the at least one of the pipe end, the clamping element including one or more flanges; and
one or more fastening elements that engages the one or more flanges to tighten the pipe fitting from an uncompressed position to a sealed engagement position with use of industry standard equipment.

2. The pipe fitting of claim 1, wherein the one or more flanges are coupled by one or more fastening elements, wherein the one or more fastening elements extend generally tangential to the generally cylindrical body portion of the sleeve and through the one or more flanges that, when tightened, creates radially applied clamping force to tightened engagement with the use of industry standard equipment.

3. The pipe fitting of claim 2, wherein one or more fastening elements is one or more fastening bolts, each of the one or more fastening bolts having a distinctive hexagonal head with an adjusted head height that enables engagement of industry standard equipment.

4. The pipe fitting of claim 3, wherein the distinctive hexagonal head further comprises a recessed portion that receives industry standard equipment to tighten the bolt.

5. The pipe fitting of claim 3, wherein the one or more flanges comprise first and second flanges, wherein the clamping element further comprises a set of two or more small fasteners, wherein the one or more fastening bolts couple the first and second flanges at a first end and the set of two or more small fasteners couple the first and second flanges at a second end, opposite the first end.

6. The pipe fitting of claim 3, wherein the one or more fastening elements are actuated from a head of the fastening bolt.

7. The pipe fitting of claim 6, wherein actuating the bolt head results in a reduction in heat generation at a nut/bolt interface.

8. The pipe fitting of claim 6, wherein the fastening bolt is actuated by a standard socket and/or square drive equipment.

9. The pipe fitting of claim 5, wherein tightening the fastening bolt provides a force required to create a seal between the sealing gasket and the at least one pipe end and engage a grip ring by bending the first and second flanges inward.

10. The pipe fitting of claim 9, wherein when fully tightened, a gap is present between ends of the first and second flanges.

11. The pipe fitting of claim 5, wherein the fastening bolt is paired with a washer and nut that are mated by shape to flange pockets allowing the first and second flanges to articulate as the fastening bolt is tightened.

12. The pipe fitting of claim 11, wherein the washer is a swivel washer and the nut is a swivel nut.

13. The pipe fitting of claim 1, wherein standard industry equipment comprises industry-standard ratchets, torque wrenches and/or electric/pneumatic impact drivers.

14. A fastener for use with a pipe fitting, the fastener comprising one or more fastening bolts having a distinctive hexagonal head with an adjusted head height, the one or more fastening bolts coupling one or more flanges of the pipe fitting and extending generally tangential to a generally cylindrical body portion of a sleeve of the pipe fitting and through the one or more flanges that, when tightened, create a radially applied clamping force to tightened engagement with the use of industry standard equipment.

15. The fastener of claim 14, wherein the distinctive hexagonal head further comprises a recessed portion that receives industry standard equipment to tighten the bolt.

16. The fastener of claim 14, wherein the one or more fastening bolts are actuated from a head of the fastening bolt.

17. The fastener of claim 16, wherein actuating the bolt head results in a reduction in heat generation at a nut/bolt interface.

18. The fastener of claim 14, wherein standard industry equipment comprises industry-standard ratchets, torque wrenches and/or electric/pneumatic impact drivers.

19. A method of fastening a pipe fitting having a sleeve, a sealing gasket operatively coupled with the sleeve for engaging at least one pipe end of at least one pipe, a clamping element operatively coupled with the sleeve for compressing the sealing gasket into tightened engagement with the at least one of the pipe end, the clamping element including one or more flanges; one or more fastening elements, the method comprising:
activating the one or more fastening elements that engages the one or more flanges to tighten the pipe fitting from an uncompressed position to a sealed engagement position using industry standard equipment.

20. The method of claim 19, further comprising activating the one or more fastening elements using industry-standard ratchets, torque wrenches and/or electric/pneumatic impact drivers.
